(19) United States
(12) Patent Application Publication
(10) Pub. No.: US 2021/0286122 A1
(43) Pub. Date: Sep. 16, 2021

(54) ILLUMINATION STRUCTURE

(71) Applicant: HONDA MOTOR CO., LTD., Tokyo (JP)

(72) Inventors: Masaru Ohira, Wako-shi (JP); Toshiyuki Araki, Sendai-shi (JP)

(73) Assignee: HONDA MOTOR CO., LTD., Tokyo (JP)

(21) Appl. No.: 17/332,299

(22) Filed: May 27, 2021

Related U.S. Application Data
(63) Continuation of application No. PCT/JP2018/045914, filed on Dec. 13, 2018.

(51) Int. Cl. F21V 8/00

(52) U.S. Cl. CPC G02B 6/0053; G02B 6/0045

(57) ABSTRACT

An illumination structure attached to a display surface side of a display structure is provided. The illumination structure includes a light guide plate, a coupling member arranged between the light guide plate and the display surface and coupled to the light guide plate, and a light source arranged so as to illuminate a side surface of the light guide plate. The light guide plate includes a first surface in contact with the coupling member and a second surface opposite to the first surface. The second surface of the light guide plate is flat. The first surface of the light guide plate includes a first portion substantially parallel to the display surface and a second portion recessed from the first portion toward the second surface side.

### CROSS-REFERENCE TO RELATED APPLICATION(S)

This application is a continuation of International Patent Application No. PCT/JP2018/045914 filed on Dec. 13, 2018, the entire disclosure of which is incorporated herein by reference.

### BACKGROUND OF THE INVENTION

### Field of the Invention

The present disclosure relates to an illumination structure.

### Description of the Related Art

As a display apparatus (for example, a liquid crystal display) including an illumination structure, a front light type display apparatus and a backlight type display apparatus are known. Since the front light type display apparatus does not consume power when there is external light, the power consumption thereof is lower than that of the backlight type display apparatus. Japanese Patent Laid-Open No. 2002-365620 proposes a liquid crystal display apparatus in which a liquid crystal panel and a light guide plate are bonded together by an adhesive layer.

In order to guide light from a light source to the display surface side, the display apparatus described in Japanese Patent Laid-Open No. 2002-365620 includes a prism in the outer surface of the light guide plate. However, when the prism is arranged in the outer surface of the light guide plate, the contrast of the display contents is deteriorated due to scattering of external light. In addition, the appearance of the display apparatus is also deteriorated due to the interference color of the prism.

### SUMMARY OF THE INVENTION

Some aspects of the present disclosure provide an illumination structure for solving at least one of the problems of the conventional front light type display apparatus. In some embodiments, an illumination structure attached to a display surface side of a display structure is provided. The illumination structure includes a light guide plate, a coupling member arranged between the light guide plate and the display surface and coupled to the light guide plate, and a light source arranged so as to illuminate a side surface of the light guide plate. The light guide plate includes a first surface in contact with the coupling member and a second surface opposite to the first surface. The second surface of the light guide plate is flat. The first surface of the light guide plate includes a first portion substantially parallel to the display surface and a second portion recessed from the first portion toward the second surface side.

Further features of the present disclosure will become apparent from the following description of exemplary embodiments with reference to the attached drawings.

### BRIEF DESCRIPTION OF THE DRAWINGS

FIG. 1 is a view for explaining a structural example of an illumination structure according to an embodiment of the present disclosure;

FIG. 2 is a view for explaining the principle of the illumination structure according to the embodiment of the present disclosure; and

FIG. 3 is a view for explaining the structure of an illumination structure according to a comparative example.

### DESCRIPTION OF THE EMBODIMENTS

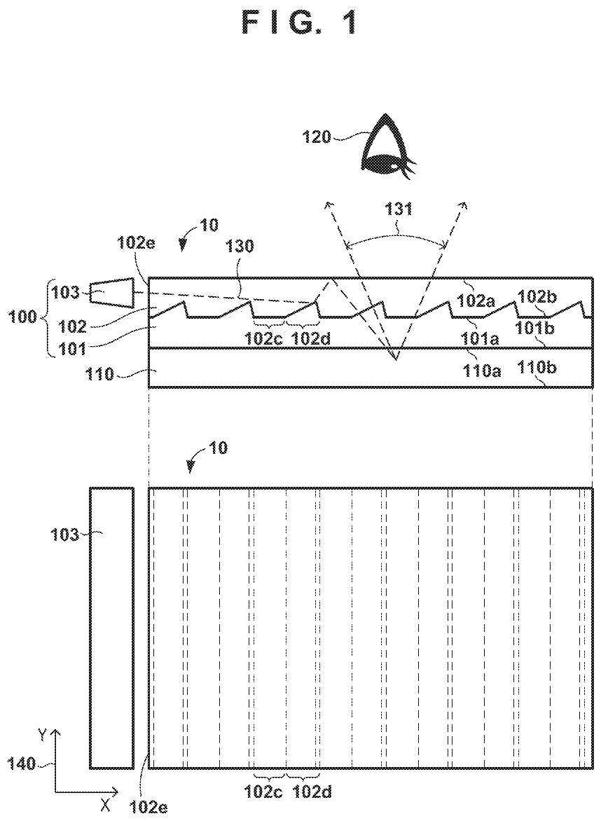

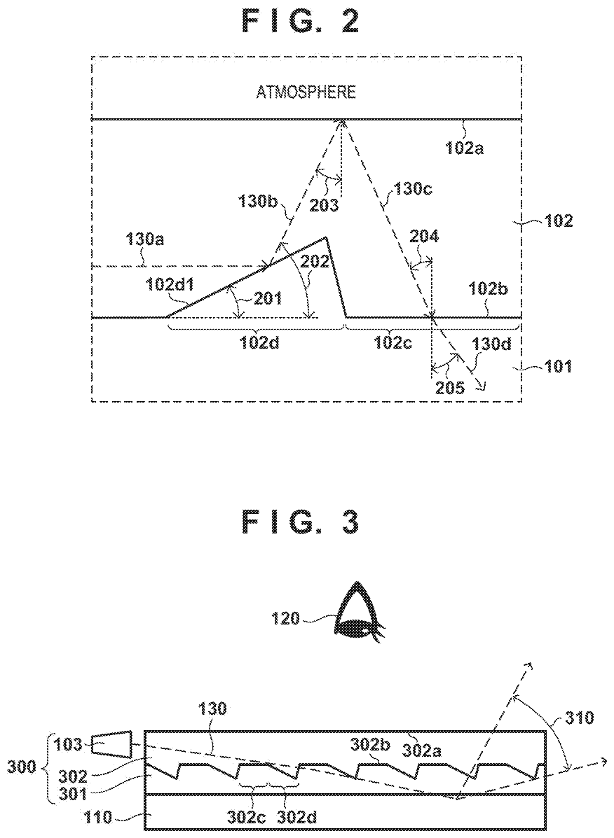

With reference to FIGS. 1 and 2, a structural example of a display apparatus 10 according to some embodiments of the present disclosure will be described. A sectional view of the display apparatus 10 is shown on the upper side of FIG. 1, and a plan view of the display apparatus 10 is shown on the lower side of FIG. 1. The display apparatus 10 includes an illumination structure 100 and a display structure 110. The display structure 110 is a display structure such as a reflective liquid crystal display. The display structure 110 includes a display surface 110a on which display contents are displayed, and a back surface 110b on the opposite side of the display surface 110a. The illumination structure 100 is attached to the display surface 110a side of the display structure 110. Accordingly, the display apparatus 10 is a front light type display apparatus (for example, a front light illumination type reflective liquid crystal display).

The illumination structure 100 includes a coupling member 101, a light guide plate 102, and a light source 103. In addition to them, the illumination structure 100 may include a switch for switching ON/OFF of the light source 103, and a battery for supplying power to the light source 103. Alternatively, ON/OFF of the light source 103 may be controlled by a signal from the display structure 110, and the light source 103 may be supplied with power from the display structure 110.

The light source 103 is arranged so as to illuminate a side surface 102e of the light guide plate 102. More specifically, the light source 103 is arranged along one side surface 102e of the light guide plate 102, and illuminates the entire side surface. If the external light reaching the display structure 110 is strong, the display contents of the display structure 110 can be read using the external light. On the other hand, if the external light reaching the display structure 110 is weak, the display contents of the display structure 110 can be read using light from the light source 103. In this manner, the front light type display apparatus is different from the backlight type display apparatus in that the light source 103 is not required to always emit light, so that the power consumption is low. The display apparatus 10 with low power consumption is used in a bicycle, a motorcycle, an automobile, a train, a ship, an airplane, a mountaineering equipment, or the like.

The coupling member 101 is coupled to both the display structure 110 and the light guide plate 102. The coupling member 101 is, for example, a cured adhesive agent used to bond the display structure 110 and the light guide plate 102. The light guide plate 102 is made of, for example, polycarbonate, and has a refractive index of, for example, 1.585. The coupling member 101 is made of, for example, silicone, and has a refractive index of, for example, 1.41. Thus, the refractive index of the coupling member 101 is lower than the refractive index of the light guide plate 102. Each of the refractive index of the coupling member 101 and the refractive index of the light guide plate 102 may be another value.

For example, the coupling member 101 may be made of a material having a refractive index lower than 1.41. Further, the light guide plate 102 may be made of a material having a refractive index higher than 1.585. The larger the difference between the refractive index of the coupling member 101 and the refractive index of the light guide plate 102, the higher the illumination utilization efficiency.

The coupling member 101 includes an upper surface 101a on the side of the light guide plate 102, and a lower surface 101b on the side of the display structure 110. The upper surface 101a and the lower surface 101b are on opposite sides. The light guide plate 102 includes a lower surface 102b on the side of the coupling member 101, and an upper surface 102a on the opposite side of the lower surface 102b. The display surface 110a of the display structure 110 and the lower surface 101b of the coupling member 101 are in contact with each other. The upper surface 101a of the coupling member 101 and the lower surface 102b of the light guide plate 102 are in contact with each other. The upper surface 102a of the light guide plate 102 faces the external world (atmosphere).

The upper surface 102a of the light guide plate 102 is flat. Therefore, deterioration of the contrast of the display contents due to scattering of the external light is suppressed. Further, deterioration of the appearance of the display apparatus 10 due to the interference color of the prism is also suppressed. The lower surface 102b of the light guide plate 102 includes recesses and protrusions. The upper surface 101a of the coupling member 101 in contact with the lower surface 102b includes corresponding recesses and protrusions.

The lower surface 102b of the light guide plate 102 includes flat portions 102c and recess portions 102d. The flat portion 102c is substantially parallel to the display surface 110a of the display structure 110. “Substantially parallel” means that the angle between two surfaces is, for example, equal to or smaller than 10°. The recess portion 102d is recessed from the flat portion 102c toward the side of the upper surface 102a of the light guide plate 102. The depth of the recess portion 102d from the flat portion 102c is, for example, about 10 μm. As shown in FIG. 1, each of the flat portion 102c and the recess portion 102d extends in a direction (the Y-axis direction of an orthogonal coordinate system 140) substantially parallel to the side surface 102e facing the light source 103. In the upper surface 101a, the flat portions 102c and the recess portions 102d are alternately arranged in a direction (the X-axis direction of the orthogonal coordinate system 140) orthogonal to the side surface 102e facing the light source 103. Each recess portion 102d functions as a prism.

The path (optical path) of light 130 emitted from the light source 103 will be described. The light 130 enters the light guide plate 102 and travels in the light guide plate 102. Then, when the light 130 reaches the lower surface 102b of the light guide plate 102 for the first time, it is totally reflected by the recess portion 102d and travels toward the upper surface 102a of the light guide plate 102. Since the light is totally reflected by the recess portion 102d, its direction is changed so as to approach the normal line of the upper surface 102a of the light guide plate 102.

Thereafter, when the light 130 reaches the upper surface 102a of the light guide plate 102 for the first time, it is totally reflected by the upper surface 102a, and travels toward the lower surface 102b of the light guide plate 102. Then, when the light 130 reaches the lower surface 102b of the light guide plate 102 for the second time, it enters the coupling member 101. After this, the light 130 enters the display structure 110 and exits, as light including the display contents, from the upper surface 102a of the light guide plate 102 in a range indicated by an arrow 131. The exit light is observed by an eye 120. By the light 130 taking such a path, in a case in which the display structure 110 is illuminated with the light from the light source 103, the image contrast is improved. Since the light 130 is totally reflected twice, the light enters the display structure 110 without exiting from the upper surface 102a of the light guide plate 102. Since the light having entered the light guide plate 102 takes such a path, the utilization efficiency of light from the light source 103 is improved.

With reference to FIG. 2, the details of the recess portion 102d of the light guide plate 102 will be described. FIG. 2 is a view focusing on a part of the sectional view on the upper side of FIG. 1. For the sake of descriptive convenience, the flat portion 102c of the lower surface 102b of the light guide plate 102 is assumed to be parallel to the display surface 110a. The upper surface 102a of the light guide plate 102 is also assumed to be parallel to the display surface 110a.

The light having entered the light guide plate 102 from the light source 103 is referred to as light 130a. The angle between the light 130a and the display surface 110a is 0°. The light 130a is totally reflected by an inclined surface 102dl of the recess portion 102d on the side of the light source 103. The totally reflected light is referred to as light 130b. Let θ1 be an angle 201 between the inclined surface 102dl and the display surface 110a. Let n1 be the refractive index of the light guide plate 102, and n2 be the refractive index of the coupling member 101. In this case, the condition of θ1 for the light 130a to be totally reflected by the inclined surface 102dl is:

θ1≤90°−arcsin(n2/n1) (1)

That is, the recess portion 102d is formed such that θ1 satisfies inequality (1).

An angle 202 between the light 130b and the display surface 110a is 2×θ1. The light 130b is totally reflected by the upper surface 102a of the light guide plate 102. The totally reflected light is referred to as light 130c. An incident angle 203 of the light 130b with respect to the upper surface 102a is 90°−2×θ1. Therefore, letting n3 be the refractive index of the atmosphere (air), the condition of θ1 for the light 130b to be totally reflected by the upper surface 102a is:

θ1≤{90°−arcsin(n3/n1)}/2 (2)

An incident angle 204 of the light 130c with respect to the flat portion 102c of the lower surface 102b of the light guide plate 102 is 90°−2×θ1. Therefore, the condition of θ1 for the light 130c to be not totally reflected by the flat portion 102c but enter the coupling member 101 is:

θ1>({90°−arcsin(n2/n1)}/2 (3)

The light having entered the coupling member 101 is referred to as light 130d. Letting θ2 be a refractive angle 205 of the light 130d, θ2 is expressed as:

θ2=arcsin({n1×sin(90°−2×θ1)}/n2) (4)

In the embodiment described above, the coupling member 101 is coupled to the display surface 110a. Instead of this, a film for improving the light utilization efficiency may be arranged between the coupling member 101 and the display surface 110a.

With reference to FIG. 3, the arrangement of an illumination structure 300 as a comparative example will be described. The illumination structure 300 includes a coupling member 301, a light guide plate 302, and the light source 103. The illumination structure 300 is different from the illumination structure 100 in that a lower surface 302b of the light guide plate 302 includes flat portions 302c and protruding portions 302d. The protruding portion 302d projects from the flat portion 302c in a direction away from an upper surface 302a of the light guide plate 302.

When the light 130 having entered the light guide plate 302 reaches the lower surface 302b of the light guide plate 302 for the first time, it enters the coupling member 301 from the protruding portion 302d. Therefore, after this, the light 130 enters the display structure 110 and exits, as light including the display contents, from the upper surface 302a of the light guide plate 302 in a range indicated by an arrow 310. As shown in FIG. 3, the exit light does not reach the eye 120.

<Summary of Embodiment>

### <Arrangement 1>

An illumination structure (100) attached to a display surface (110a) side of a display structure (110), the illumination structure comprising:

a light guide plate (102);

a coupling member (101) arranged between the light guide plate and the display surface and coupled to the light guide plate; and

a light source (103) arranged so as to illuminate a side surface (102e) of the light guide plate,

wherein the light guide plate includes a first surface (102b) in contact with the coupling member and a second surface (102a) opposite to the first surface,

the second surface of the light guide plate is flat, and

the first surface of the light guide plate includes a first portion (102c) substantially parallel to the display surface and a second portion (102d) recessed from the first portion toward the second surface side.

According to this arrangement, deterioration of the contrast of the display contents due to scattering of external light is suppressed. Further, deterioration of the appearance of the display apparatus 10 due to the interference color of a prism is also suppressed.

### <Arrangement 2>

The illumination structure according to Arrangement 1, wherein

the second portion is formed such that light having reached the first surface form the light source for the first time is totally reflected and light totally reflected by the first surface is totally reflected by the second surface.

According to this arrangement, the utilization efficiency of light from the light source is improved.

### <Arrangement 3>

The illumination structure according to Arrangement 2, wherein

the second portion is formed such that light totally reflected by the second surface of the light guide plate is transmitted through the first surface of the light guide plate.

According to this arrangement, the utilization efficiency of light from the light source is further improved.

<Arrangement 4>

The illumination structure according Arrangement 1, wherein

θ1≤90°−arcsin(n2/n1),

θ1≤{90°−arcsin(n3/n1)}/2, and

θ1>{90°−arcsin(n2/n1)}/2

are satisfied, where n1 is a refractive index of the light guide plate, n2 is a refractive index of the coupling member, n3 is a refractive index of air, and θ1 is an angle between an inclined surface of the light source side of the second portion and the display surface.

According to this arrangement, the utilization efficiency of light from the light source is improved.

The present invention is not limited to the above embodiments and various changes and modifications can be made within the spirit and scope of the present invention. Therefore, to apprise the public of the scope of the present invention, the following claims are made.

What is claimed is:

1. An illumination structure attached to a display surface side of a display structure, the illumination structure comprising:
a light guide plate;
a coupling member arranged between the light guide plate and the display surface and coupled to the light guide plate; and
a light source arranged so as to illuminate a side surface of the light guide plate,
wherein the light guide plate includes a first surface in contact with the coupling member and a second surface opposite to the first surface,
the second surface of the light guide plate is flat, and
the first surface of the light guide plate includes a first portion substantially parallel to the display surface and a second portion recessed from the first portion toward the second surface side.

2. The illumination structure according to claim 1, wherein
the second portion is formed such that light having reached the first surface from the light source for the first time is totally reflected and light totally reflected by the first surface is totally reflected by the second surface.

3. The illumination structure according to claim 2, wherein
the second portion is formed such that light totally reflected by the second surface of the light guide plate is transmitted through the first surface of the light guide plate.

4. The illumination structure according claim 1, wherein
θ1≤90°−arcsin(n2/n1),
θ1≤{90°−arcsin(n3/n1)}/2, and
θ1>{90°−arcsin(n2/n1)}/2
are satisfied, where n1 is a refractive index of the light guide plate, n2 is a refractive index of the coupling member, n3 is a refractive index of air, and θ1 is an angle between an inclined surface of the light source side of the second portion and the display surface.
